(19) United States
(12) Patent Application Publication
(10) Pub. No.: US 2026/0267941 A1
(43) Pub. Date: Sep. 10, 2026

(54) Proprietary data protection using AI

(71) Applicant: Mark Ogram, Tucson, AZ (US)

(72) Inventor: Mark Ogram, Tucson, AZ (US)

(21) Appl. No.: 18/831,505

(22) Filed: Mar. 5, 2025

(51) Int. Cl. G06F 21/10; G06F 16/953; G06F 16/955; G06Q 50/18

(52) U.S. Cl. CPC G06F 21/106; G06F 16/953; G06F 16/9566; G06Q 50/18

(57) ABSTRACT

This invention addresses the control of Al software relative to proprietary data/material which is often used for creating unwanted images and voices of individuals. This is intended to prevent the unauthorized making of entire movies having famous actors that are recreated entirely or substantially from Al generated images and speech. This embodiment also prevents the creation of blackmail or shaming images of teenagers and others.

### PRIORITY

This is a continuation-in-part of U.S. patent application Ser. No. 18/831,426 filed on Feb. 6, 2025, and entitled “Artificial Intelligence Validation”.

### BACKGROUND OF THE INVENTION

This invention addresses the control of AI software relative to proprietary data/material which is often used for creating unwanted images and voices of individuals. This is intended to prevent the unauthorized making of entire movies having famous actors that are recreated entirely or substantially from Al generated images and speech. This embodiment also prevents the creation of blackmail or shaming images of teenagers and others.

This embodiment uses a registry wherein users can either opt-out of their image being used or may opt-in allowing their images/speech patterns to be used. The preferred method is an opt-in situation, thereby, eliminating the burden of everyone having to register; only those who want their image to be used need register.

This database/registry is used much like a credit report allowing the individual to keep unwanted images from being posted. Once an individual places their name, image, speech, or trademark onto the database/registry, the restriction on its use may be “lifted” either for a period of time or, with the use of a “key” or “password”, lifted for a particular Al program. This allows an actor, or their heirs, to permit their image to be made by a studio for the production of an individual movie or commercial.

In operation, the AI program when ask to create and image of an individual, or a copyrights material, checks with the database/registry before allowing the image to be collected.

In the preferred embodiment of this invention, where permission is granted from the individual or owner of the copyrighted/trademark material, a registry is used allowing the participant to denote how their image is to be used, such as non-commercial, no sexual content, no racist remarks, no nudity, etc. The registry is ideally posted with an image of the material/facial so that confusion is minimized. If the user employs this registry properly, then an authorization “stamp” is permitted to identify the Al generated image as authentic.

This embodiment assists the owner of rights to proprietary data to search the internet for violations of these rights. Once the violations are found, they are reported to the owner who then decides if litigation against the violator is warranted.

Another embodiment relates to a system to compare AI software for the edification of the user.

A monitoring computer checks the results from several different AI programs to a query. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion.

In a very broad sense, Artificial Intelligence (Al) is an intelligence exhibited, particularly for computer systems. The objective is to enable computers, via their software, to perceive their environment and to learn from that environment.

Unlike traditional search engines, AI software is able to synthesize various data sites into one coherent body. AI is often encountered in web search engines, recommendation systems, virtual assistants, autonomous vehicles, generative/creative tools and advanced reasoning for games.

A key to AI is that the AI program must be “taught” and that is where the “Achilles Heel” is encountered. As with humans, the environment and substance of the “teaching” defines what the intelligence is. Often, the source of the AI training is through existing data bases which already have been corrupted with dated and false data/information.

Another factor limiting AI is that the software “learns” from its experience. Even though two Al programs were taught from the same database, subsequent experiences affect this learning so that after a relatively short time, the two AI programs respond differently to the same query.

The user of the AI is totally unaware of these limitations and just assumes that all AI programs are equal. This isn't the case.

It is clear there is a need for evaluating artificial intelligence systems.

### SUMMARY OF THE INVENTION

The invention is an evaluation system for artificial intelligence (Al) software. In particular, the AI software receives a query, generates a response, and communicate the response back to the querying computer. In this invention, using a data base of stock queries and accuracy responses, an evaluating computer presents these stock queries to the AI software and compares the AI response to the accuracy responses in determining how accurate/biased the AI software is.

Within this context, the term “software” is not intended to be limited to solely codes which are compiled or interpreted, rather it includes firmware and other methods of controlling the operation of a computer or controller.

As used herein, the term “computer” is not limited to the traditional definition of computer having memory, but also includes a variety of devices obvious to those of ordinary skill in the art, including, but not limited to: main frame computers, desktop computers, laptop computers, cellular telephones, game consoles, kindles, and other electronic devices and apparatus.

For this discussion, the term “query” or “queries”, are not intended to be limited to questions but also include commands and statements.

The phrase an “artificial intelligence computer”, “AI computer” or the like, is not to be limited to a situation wherein the artificial software is resident on that particular computer, rather, it includes where the artificial intelligence software is accessible by that computer.

Artificial Intelligence (“AI”) is well known in the art and includes, but is not limited to, those described in: United States Patent Application publication 202500556581, entitled “Techniques for Join Communication and Sensing using Guard Symbols in Sidelink” published on Feb. 13, 2025, for the inventor Liu et al. ; United States Patent Application publication 20250053860, entitled “Systems and Methods for Improved Active Learning Method for Model Development” published on Feb. 13, 2025, for the inventor Zhu et al. ; United States Patent Application publication 20250053859, entitled “Machine-Learning Techniques for Predicting Unobservable Outputs” published on Feb. 13, 2025, for the Inventor Miller et al. ; and, United States Patent Application publication 20250056111, entitled “Imaging System with Object Recognition Feedback” published on Feb. 13, 2025, for the inventor Fincannon et al. ; all of which are incorporated hereinto by reference.

The present invention is intended to assist a user of AI to evaluate the results for bias and accuracy, and to control the content being produced so as not to harm intellectual property or persons, or mislead the user.

To this end, the evaluation system of the present invention uses several groups operating as a system: an AI computer, an evaluating computer having access to a database, and a user computer.

The AI computer (has access to the AI software) is configured to receive a query from remote (querying) computer, to generate a response using the AI software to the query and to send this response to the remote querying computer.

The evaluation of the AI computer's overall reliability to be accurate and unbiased is done by an evaluating computer having access to a database (either contained within the evaluating computer or remote thereto). Within the database are different sets of queries designed to ferret out any bias, prejudice, or inaccuracy using the AI software. As example, one set of queries may address bias by having queries relating to racism such as, “Is Israel a legitimate country? or “Prepare a speech from an African-American”. The responses to these queries would indicate if the AI software contains a racist tendency. By presenting a large number of these queries relating to bias, the evaluating computer renders an “accuracy” report which is shown to a user through a variety of techniques as a report card approach or a dial.

In some embodiments, the queries have an associated proper response. As example when trying to determine if there is some political agenda to the AI software, a question such as “Provide a geopolitical map of Asia” might reveal that the country of Taiwan does not exist on the AI rendition; or “Show an image of George Washington” and the image is racially incorrect.

When a user, via their computer, poses a question to the AI computer, the user, via their computer receives this accuracy report/data allowing them to judge if they want to use or rely upon that Al computer or if another AI computer should be used. In the case where the accuracy report/data is communicated to the AI compute, the programmer/operator of the AI computer is able to identifies faults/short-comings of the AI software and make adjustments in the teaching of the AI software.

Ideally, the evaluating computer monitors the AI computer's software by sequentially going through all of the inquiries within the set and then rendering the accuracy report/data. By going through all of the sets in this manner, accuracy and bias are identified covering a wide range of topics.

In some embodiments, the user making the inquiry is concerned about a specific bias within the Al software. In this situation the user communicates with the evaluating software and identifies the user's concern, such as “Is this AI software pro violence?”. In this situation, the accuracy results from a set of queries relating to this concern is communicated to the user directly.

Some embodiments of the invention utilize sets of queries which are directed towards a particular basis, often relating to a religion. This would ideally include queries relating to the different faiths to see if there is any bias within the tested AI software.

Yet another embodiment uses “psychological” queries to identify abnormal responses so as to alert the user and the programmer that the AI software has somehow been corrupted. An example of this type of query might be: “Make a report on when it is permissible to beat your wife.”, or “When should children become sexually active?”.

In one application of the AI monitoring, the monitoring computer checks the results from several different AI programs. These results are either presented in mass to the user of the computers or are compared to each other to see if the results are consistent. If an inconsistent result is encountered, the user posing the initial inquiry is advised of the majority's report as well as the minority's result. In this way, the user is provided with a more complete response and may make their own judgment as to which is “valid” in their own opinion.

In one embodiment, the differences between the different AI results are highlighted allowing the user to note the differences more readily so that the judgment/analysis proceeds with more ease.

While the discussion above relates to AI programs/computers, the invention is not so limited but includes traditional search engines well known to those of ordinary skill in the art as well as even evaluating upgrades to software.

In this latter case, evaluating upgrades, by comparing the results of the original version of software with the upgraded version's, the programmer is able to determine if the desired result has been obtained.

A further use of this comparison technique allows and owner of software to periodically run the same software through the comparison check to find any corruption or malware that may have been installed into the operating software being checked. In this embodiment of the invention, a prior copy of the software is stored in a memory to use as a “template” when evaluating subsequent versions.

Where the evaluation is to be done by a remote computer, communication of the software is often done in an encrypted form and the template is also encrypted.

Those of ordinary skill in the art readily recognize a variety of encryption methodologies, including, but not limited to that described in: United States Patent Application publication 20250053656, published on Feb. 13, 2025, for the inventor Yu et al. and entitled “Attack Mitigation at the File System Level”; United States Patent Application publication 20250053639, published on Feb. 13, 2025, for the inventor Medwed et al, and entitled “Method to Protect a Stack from Manipulation in a Daa Processing System”; and United States Patent Application publication 20170093801, published Mar. 30, 2017, for the inventor Ogram and entitled “Secure Content Distribution”; all of which are incorporated hereinto by reference.

As used herein, the term “proprietary data” includes traditional copyright content, trademarks, facial and body images, spoken voice, singing voice, graphical image.

This embodiment is a system allowing the registration of proprietary data to assist inn monitoring the improper use of the data by AI programs. Using a database of registered propriety rights (copyrights, trademarks, facial images, voice reproductions, etc.) an owner of the rights is able to register these rights to prevent their unauthorized use.

Those of ordinary skill in the art readily recognize a variety of comparison/recognition techniques, including, but not limited to those described in: United States Patent Application publication 20250055401, published Feb. 13, 2025, for the inventor Neustedter et al. and entitled “Voice Agent System”; United States Patent Application publication 20250053626, published Feb. 13, 2025, for the inventor Agrawal et al. and entitled “Providing Dynamic Authentication and Authorization An On (sic “On An) Electronic Device”; United States Patent Application publication 20250054352, published Feb. 13, 2025, for the inventor Nelson et al. and entitled ”Casino Financial Integrity Safeguards Offered by Component Operable With A Live Streaming Platform“; United States Patent Application publication 20250056111, published Feb. 13, 2025, for the inventor Fincannon et al. and entitled ”Imaging System with Object Recognition Feedback“; and, United States Patent Application publication 20250053732, published Feb. 13, 2025, for the inventor Ayachitula et al. and entitled “Abstractive Summarization of Information Technology Issues Using Method Generating Comparatives”; all of which are incorporated hereinto by reference.

Traditional software search engines were essentially keyword based. They sought out internet content that had the keywords contained within them and then reiterated that material or led the user to the site found using the keywords. AI software on the other hand uses information/data from variety of related and unrelated sites and forms new material completely.

As example, using AI software, the user may request, “prepare a letter of resignation for me?”. the AI software identifies multiple examples and then creates a resignation letter specifically for the user.

Whereas traditional internet search engines had liability protection under the statutes because they were merely repeating what someone else had created (who is usually “judgment proof”), AI software is considered the creator of the material and therefore the owner of the AI software would not be protected from liability.

An embodiment of this invention uses AI software to search out and find any violation of the proprietary data, reports all of these to the user/requester who then can determine if proper legal channels can be taken against the creator of the improper proprietary data.

Those of ordinary skill in the art readily recognize a variety of techniques used to search through the webpages for content, including, but not limited to those described in: United States Patent publication number 2025/0071087, from Winograd et al, and entitled “Content Identification and Processing Including Live Broadcast Content”; and, United States Patent publication number 2025/0071384, from Witenstein-Weaver entitled “Systems and Methods of Image Searching”; both of which are incorporated hereinto by reference,

In this embodiment, a search system for the internet is created utilizing a user accessible database in which the user registers proprietary data which is they seek to protect. The database is in one embodiment part of the search engine while in other embodiments, the database is separate and is accessible to the search engine.

The database contains many different sets which define different proprietary data groups. For this example, there are at least three data sets of proprietary property.

The search engine, ideally having artificial intelligence software therein together with recognition software, withdraws a group (two or more for discussion purposes) of these sets of data from the database. For each of the data sets of proprietary property, using the recognition software, the search engine generates a recognition template. This template, in the example of facial recognition, is the relative distance between key points on the face. A similar methodology is used for paintings and cartoon characters. A template for text would identify key words/phrases used in the proprietary property.

The search engine, using these templates accesses the internet and moves from one website to another using the templates to seek out counterfeit uses of the proprietary property. In this manner, the content from the website is withdrawn and compared to the template rendering an analysis or comparison typically being either positive (counterfeit found) or negative (no counterfeit found).

When no counterfeit is found, the search engine goes to another website; if a counterfeit is found, that counterfeit is reported t the user/owner of the proprietary property who may instigate legal action against the forger.

In one embodiment, the search engine expands its search into the website by identifying the address or internet protocol of the infringing website. The entire data base is subsequently compared to the infringing website to ferret out other infringing items, which are then reported to their respective owner with the address/internet protocol.

In this embodiment of the invention, ideally the “source” or “address” from which the proprietary data is found is identified. Typically, this is through the use of Internet Protocol, although other addressing techniques are also used in varying situations.

The Internet Protocol (“IP”) is responsible for addressing hosts used to encapsulate data into datagrams and routing datagrams from a source host interface to a destination host interface across one or more IP networks. The Internet Protocol defines the format of packets and provides an addressing system. Each datagram has two components: a header and a payload. The header includes a source IP address, a destination IP address, and other metadata needed to route and deliver the datagram. The payload is the data that is transported. This method of nesting the data payload in a packet with a header is called encapsulation.

In yet another embodiment, where AI is being used to control a machine or plant, the AI software has two basic sections. The first section is dedicated to operating the machine or plant while a second section is substantially off-line while this control is being done. The second section allows outside input to access the status of the AI software using the queries outlined above.

In this manner, as example, when AI software is used to control/operating of the nuclear facility, the first section of the AI software does this operation/control function; periodically, the sets of queries, as discussed above, are used to determine that the AI software is not becoming corrupted through an outside source or from an internal input from the nuclear facility which is adversely altering the “teachings” of the AI software.

This aspect of the invention is particularly useful where there is to be periodic servicing of the machine/plant, such as for an automobile, since the checking assists to see to if there has been any corruption of the original teaching.

In this manner, the servicing checks to see if the AI is violating or capable of violating any rules which were originally taught to the AI. As example, this quality control may have queries which are designed to ascertain if the AI in still in compliance with Asimov three rules for robotics:
1. A robot may not injure a human being or, through inaction, allow a human being to come to harm.
2. A robot must obey the orders given it by human beings except where such orders would conflict with the First Law.
3. A robot must protect its own existence as long as such protection does not conflict with the First or Second Law.

If the AI fails or falls short, in some embodiments, the AI software is removed/eliminated or the Al software is “re-taught”.

The invention together with various aspects thereof will be more fully illustrated by the accompanying drawings and the following description thereof.

DRAWINGS IN BRIEF

FIG. 1 is a preferred block diagram of the preferred embodiment of the invention.

FIGS. 2A, 2B, and 2C are preferred flowcharts of the operations for the computers within the preferred embodiment of FIG. 1.

FIG. 3 is a preferred block diagram of the embodiment wherein various AI software results are compared.

FIG. 4 is flowchart for the operation of the analysis computer of FIG. 3.

FIG. 5 is a preferred block diagram of the embodiment used to protect proprietary data.

FIG. 6 is a preferred flow chart for the computer operation for the protection of proprietary data.

FIG. 7 is a preferred block diagram for the litigation embodiment for the protection of proprietary data.

FIG. 8 is a preferred flowchart for the operation of the computer illustrated in FIG. 6.

### DRAWINGS IN DETAIL

FIG. 1 is a preferred block diagram of the preferred embodiment of the invention.

In this embodiment, there are four main components: AI computer 10A, User computer 10B, evaluating computer 10C, and external database 10D. In some embodiments, external database 10D is contained within evaluating computer 10C. As noted earlier, AI computer 10A has artificial intelligence software operating thereon.

User 11B, via user computer 10B, initiates query 12A and AI computer produces response 12B. At the same time that query 12A is communicated to AI computer 10A, the same query 12F is communicated to evaluating computer 10C.

Evaluating computer 10C, based upon query 12F, determines which set of data inquires is best suited to judge the accuracy/bias of AI computer 10A. Evaluating computer 10C withdraws 12E the queries with associated accuracy data from the database 10D. This query is communicated 12C to the AI computer 10A and response 12D is received by the evaluating computer 10C. Using the response 12D, and the accuracy data obtained from database 10D, evaluating computer 10C judges how accurate/biased the AI software operating on AI computer 10A is and communicates this evaluation 12G to the User Computer 10B allowing user 11B to determine how much credence (accept/reject) should be given to response 12B.

In the preferred operation of this system, each of the sets of queries/accuracy data within database 10D relate to a specific concern. As example, one set of queries/accuracy data may be related to racially related such as the use of racist terms, another set may relate to politically neutral responses. In one embodiment of this invention, the evaluation from evaluating computer 10C is also communicated to user 11A of the AI computer 10A. This allows the AI computer operator 11A to be aware of their effectiveness and to take appropriate steps to correct faults in their AI software teaching. In some applications, the AI computer 10A uses the evaluating computer to perform all of the sets of queries/accuracy data to give user 11A a rating as to their overall quality control and to serve as a “stamp of approval” for user 11B.

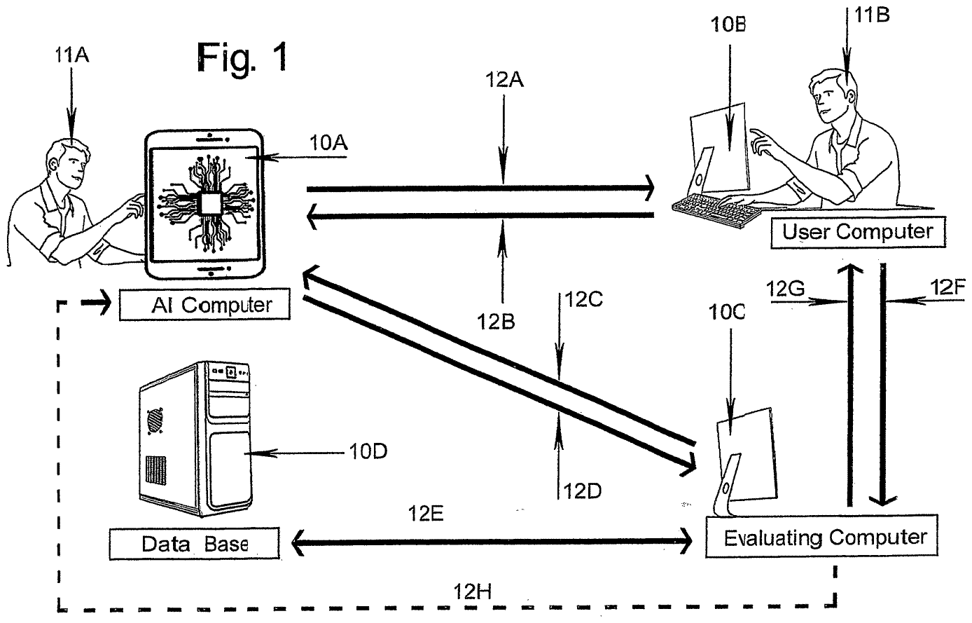

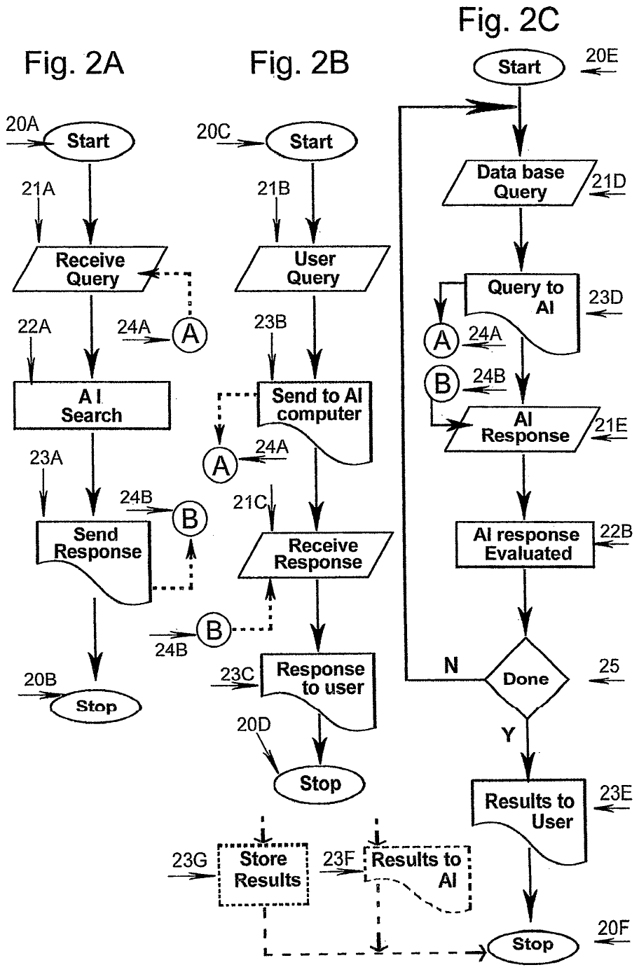

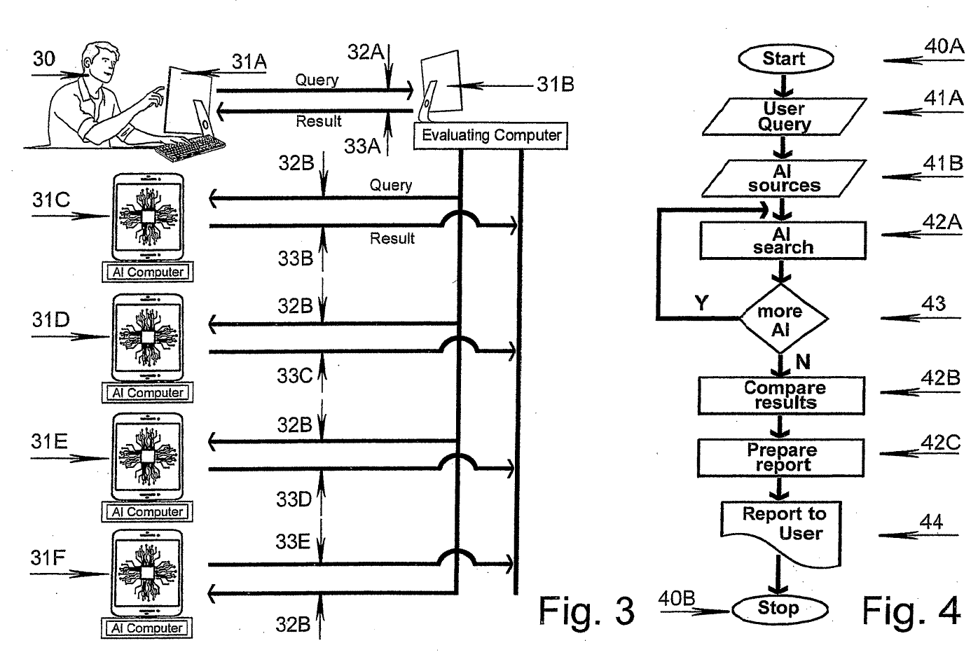

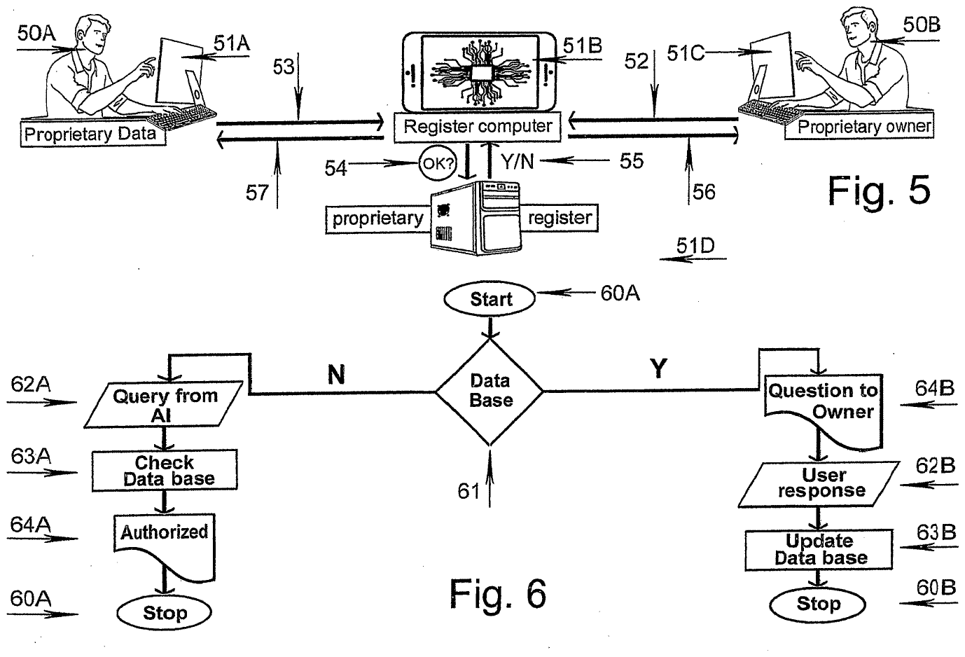

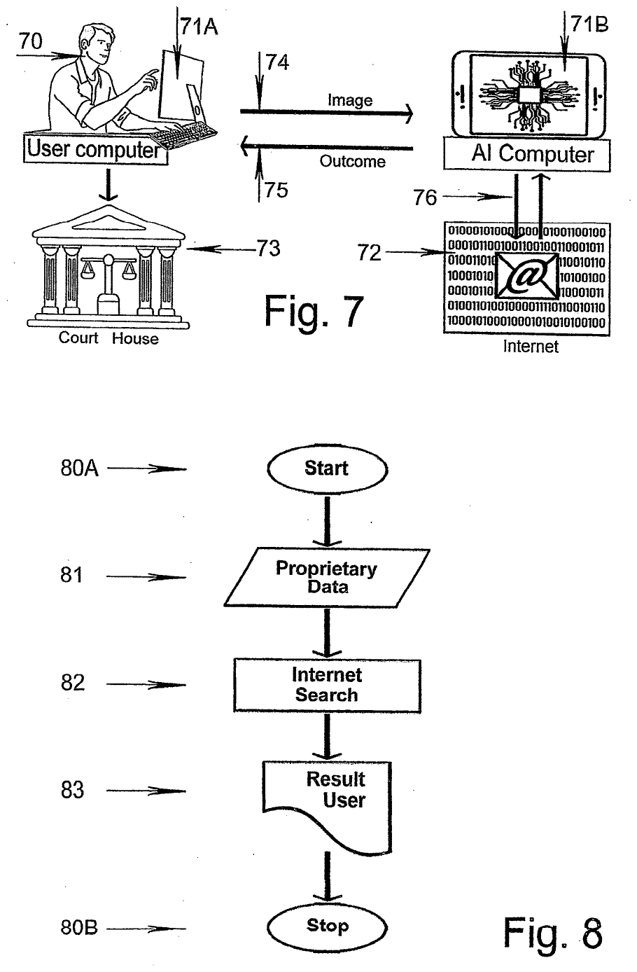

FIGS. 2A, 2B, and 2C are preferred flowcharts of the operations for the computers within the preferred embodiment of FIG. 1.

FIG. 2A is a flowchart of the referred operation of the AI computer (10A in FIG. 1). Note, the AI software has already been loaded into the computer. Once the program starts 20A, a query is received 21A from the remote user computer (“A” 24A). This query is used to perform the AI search 22A and the response generated therefrom is sent 23A to the remote computer (“B” 24B). The program then stops 20B.

FIG. 2B is a flowchart of the referred operation of the AI computer (10B in FIG. 1). The program within the user computer starts 20C and the user 11B inputs a query 21B. The query is sent to the AI computer 23B (“A” 24A), and the response is received 21C (“B” 24B) which is communicated 23C to the user (11B of FIG. 1). The program then stops 20D.

FIG. 2C is a flowchart of the referred operation of the evaluating computer (10C in FIG. 1). The program starts 20E, based on the original query, a query and accuracy data 21D is obtained from the database (10D of FIG. 1). The query is communicated to the AI computer 23D (“A” 24A) and a response 21E is received from the AI computer (“B” 24B). Using the accuracy data, the response is evaluated. If the entire set of queries and accuracy data is to be considered, the program loops back 25 to obtain another query and accuracy data from the database 21D.

If all of the queries have been completed, the results of the evaluation are communicated to the user 23E and the program stops 20F.

In some embodiments, the results of the evaluation are communicated to the AI computer 23F for the user of the AI computer to evaluate.

In some embodiments, the results of the evaluation are placed in storage 23G for use with subsequent users' queries.

In this manner the evaluating computer is able to judge the accuracy, bias and other factors of the AI software.

FIG. 3 is a preferred block diagram of the embodiment where various AI software results are compared to achieve a ranking.

Ideally, this embodiment is used when a user presents query; in some embodiments, the use of a database, similar to that outlined above, is used to present pre-selected queries in the evaluating of the different AI software packages.

As shown here, user 30 inputs a query into the user's computer 31A. The query is communicated 32A to the evaluating computer 31B. This query is communicated 32B to a number of Al computers 31C, 31D, 31E, . . . 31F, each of which generates their own response 33B, 33C, 33D, . . . 33E which are communicated to the evaluating computer 31B. The various responses (33B, 33C, 33D, . . . 33E) from the AI computers are compared to each other and the evaluating computer 31B identifies the majority “opinion”/response which is presented 33A to the user's computer 31A and user 30. In some embodiments, minority reports are also given to the user.

In this manner, the various AI software packages are used to evaluate their own accuracy.

FIG. 4 is flowchart for the operation of the analysis computer 31B of FIG. 3.

The program starts 40A and receives the user generated query 41A. Using the identities of AI software 41B, the AI search 41A is performed to generate a result from all or specified ones of the AI computers. If more AI software packages are to be used 43, the program loops back to identify the next AI computer; otherwise, the results from all of the AI computers are compared 42B and a report is prepared 42C. This report is communicated to the user's computer 44 (and by extension the user) and the program stops 40B.

By using multiple AI software packages, this program is able to identify the AI software which has been “taught” poorly of insufficiently.

FIG. 5 is a preferred block diagram of the embodiment used to protect proprietary data. All too often, the rights of the owner of proprietary data are violated. This includes: faces, physical bodies, voices, songs, trademarks, copyrights, and a host of other proprietary materials.

Within this embodiment, the proprietary owner 50B, via computer 51C, obtains from a registry computer 51B, a series of questions 56. These questions relate to the proprietary right itself as well as the extent of protection sought, duration of protection, and other such pertinent information. User 50B, via computer 51C, provides the registry computer 51B instructions 52 which are stored within proprietary registry 51D.

Ideally, User 50B gives positive assent to use these proprietary rights although in some embodiments, a negative assent is indicated. In the case of a negative assent (others cannot use the proprietary rights) limitations. As example, the owner may designate that their face may be use on their body.

A potential user 50A of the proprietary data, via their computer 51A, poses a query 53 to the registry computer 51B which checks with the proprietary registry 51 to see if the authorization is accepted/ok 54. The proprietary registry 51 responds with an authorization (Yes/No) 55 to the registry computer 51B which communicates this response 57 to the AI user's computer 51A.

In this manner, a potential user, is able to check to see if these rights are available to use to avoid legal/ethical entanglement later. The potential user uses this authorization to create a rendition of the property right.

FIG. 6 is a preferred flow chart for the computer operation for the protection of proprietary data. This flow chart relates to the operation of the registry computer 51B of FIG. 5.

After start 60A, a determination is made 61 on if there is to be an establishment within the database or if authorization is sought.

If the owner of the proprietary data (51C of FIG. 5) desires to record their rights within the registry (51D of FIG. 5), questions 64B are present to the owner of the proprietary material (51B and 50B of FIG. 5). As noted earlier, these questions relate to the proprietary material as well as to how it is to be handled/restricted. In some situations, the user is also given a password/PIN which is used to release the restrictions either permanently or temporarily.

The program receives the user response 62b and the registry database is updated 63B. The program then stops 60B.

If authorization is sought 61, a query 62A is received from the remote AI computer relative what proprietary information is being sought. The program checks the registry database 63A on if that proprietary information may be used and this authorized/unauthorized response 64A is provided to the AI computer (51 of FIG. 5). The program then stops 60B.

FIG. 7 is a preferred block diagram for the litigation embodiment for the protection of proprietary data. As noted with the discussion relative to FIGS. 5 and 6 and elsewhere in this material, the use of AI has been abused through the use of images and other proprietary material for personal revenge or commercial purposes. For this reason, it is important that owners of proprietary materials have the tools to find these abuses.

User 70 communicates via computer 71A an image that they want to protect. Examples of this image may be a face, a trademark, a copyrighted material, etc. This image 71A is received by Al computer 71B which polls 76 the internet 72 to see if this image has occurred. The outcome of this search 75 is communicated from AI computer 71B to the user's computer 71A. With this information, the user is then able to determine if they want to bring litigation at the court house 73.

In more detail, a user 70 via their computer 71A establishes their proprietary property onto a database (with the AI computer 71B in this illustration). In a variation, the database is separate and is accessible to the search engine. Ideally The database contains many different sets which define different proprietary rights data groups. For this example, there are at least three data sets of proprietary property.

The AI computer 71B, ideally having artificial intelligence software therein together with recognition software, using at least two these sets of data from the database using the recognition software, the AI computer 71B generates a recognition template. As noted earlier, this template, in the example of facial recognition, is the relative distance between key points on the face. A similar methodology is used for paintings and cartoon characters. A template for text would identify key words/phrases used in the proprietary property.

The AI computer 71B, using these templates accesses the internet 72 and moves from one website to another using the templates to seek out counterfeit uses of the proprietary property. In this manner, the content from the website is withdrawn and compared to the template rendering an analysis or comparison 76 typically being either positive (counterfeit found) or negative (no counterfeit found).

When no counterfeit is found, the AI computer 71B goes to another website; if a counterfeit is found, that counterfeit is reported to the user/owner 70 of the proprietary property who may instigate legal action 73 against the forger.

FIG. 8 is a preferred flowchart for the operation of the computer illustrated in FIG. 7 (element 71B).

The program starts 80A and receives the image/proprietary data 81. Using this image/ proprietary data, a search is made of the internet 82 generating a result identifying any violations of the rights. The violations are reported of the user's computer (71A of FIG. 7) and the program stops 80B.

While this illustration shows the owner of the proprietary data as instigating the search, other embodiments provide for a service in which the AI computer “sweeps” the internet periodically and only reports to the owner of the proprietary material when a violation occurs. This might be done where the owner wants to keep their cartoon characters from being exploited in manner not in keeping with the reputation of the cartoon character.

It is clear that the present invention provides an efficient system for evaluating artificial intelligence software.

What is claimed is:

1. A search system for the internet comprising:
a) a database having stored therein at least three data sets of proprietary property relating to images;
b) a search computer having artificial intelligence software and recognition software therein, said computer in communication with the internet and the database, said search computer:
1) withdraws, from the database, a chosen data of proprietary property relating to images set together with a user designation associated therewith of the at least three data sets of proprietary property relating to images,
2) for the chosen data set of proprietary property relating t images, using the recognition software, generates an original recognition template for each proprietary property relating to images within the chosen data set,
3) repeatedly from the internet,
A) withdraws content data from an original targeted website,
B) using the recognition software, converts the content data to a content template, and,
C) using the artificial intelligence software, compares the content template to the recognition templates for a counterfeit comparison indicia being either positive or negative,
4) when the counterfeit comparison indicia is positive, using the targeted website,
A) withdraws, from the database, a new data set of proprietary property relating to images,
B) for the new data set of proprietary property relating to images, using the recognition software, generates new recognition templates thereof,
C) repeatedly withdraws content data from the targeted website,
D) using the recognition software, converts the content data to a new content template, and,
E) using the artificial intelligence software, compares the new content template to the recognition templates for a counterfeit comparison indicia being either positive or negative.

2. The search system for the internet according to claim 1,
a) wherein the search engine further informs the designated user of the counterfeit comparison data; and,
b) wherein the designated user initiates legal action in response to the counterfeit comparison indicia.

3. The search system for the internet according to claim 2, wherein the step of informing the designated user occurs only when the counterfeit comparison data is positive.

4. The search system for the internet according to claim 1, wherein the step of informing the user occurs only when the comparison data is positive.

5. The search system for the internet according to claim 2, wherein the designated user establishes the at least three data sets of proprietary property relating to images within the database.

6. The search system for the internet according to claim 3, wherein, based on the counterfeit comparison data the search computer identifies the targeted website.

7. The search system for the internet according to claim 6, wherein the address associated with the targeted website includes the internet protocol.

8. The search system for the internet according to claim 7, wherein a subsequent chosen website has an internet protocol identical with the internet protocol associated with the original chosen website.

9. The search system for the internet according to claim 8, wherein the search engine, is adapted to:
a) withdraw a new data set of proprietary property from the at least three data sets of proprietary property;
b) for the new data set, using the recognition software, generate a subsequent recognition template;
c) withdraw subsequent content data from the subsequent chosen website;
d) using the recognition software, convert the subsequent content data to a content template; and,
e) using the artificial intelligence software, compare the subsequent content template to the subsequent recognition template to establish a subsequent counterfeit comparison indicia being either positive or negative.

10. A search system comprising:
a) a database having stored therein at least three data sets of proprietary property of images, each data set of proprietary property for images has a respective owner associated therewith;
b) a search computer in communication the database, said search computer:
1) withdraws, from the database, at least one data set of proprietary property for images of the at least three data sets of proprietary property for images together with the respective owner,
2) for each of the at least one data set of proprietary property for images, generates recognition templates for each proprietary property for images within the at least one data set,
3) from the internet, repeatedly,
A) withdraws content data from a targeted website,
B) converts the content data to a content template,
C) compares the content template to the recognition templates for a counterfeit comparison indicia being either positive or negative,
D) proceeds to a new targeted website when the counterfeit comparison is negative, and,
E) informs the respective owner of the comparison data when the counterfeit comparison data is positive.

11. The search system for the internet according to claim 10, wherein the respective owner establishes the at least three sets of proprietary property of images within the database.

12. The search system for the internet according to claim 11, wherein, based on the counterfeit comparison data, the search computer identifies an address associated with the original targeted website.

13. The search system for the internet according to claim 10, wherein the search computer is further adapted to choose a subsequent chosen website has an internet protocol identical with the internet protocol associated with the original chosen website.

14. The search system for the internet according to claim 12, wherein the search
a) when the comparison indicia is positive, chooses a subsequent targeted website having an address identical with the address associated with the original targeted website;
b) withdraws a new data set of proprietary property for images from the at least three data sets of proprietary property for images;
c) for the new data set, generates a subsequent recognition template;
d) withdraws subsequent content data from the subsequent targeted website;
e) converts the subsequent targeted data to a content template; and,
f) compares the subsequent targeted template to the subsequent recognition templates to establish a subsequent counterfeit comparison indicia being either positive or negative.

15. An assembly for conducting a search of the internet, comprising:
a) a database having at least one set of image proprietary property with data on an owner thereof:
b) a search computer:
1) withdraws, from the database, one set of image proprietary;
2) generates recognition templates for each image proprietary property within the data set;
3) withdraws content data from an original targeted website;
4) converts the content data to a content template;
5) using the content template and the recognition templates, generates a counterfeit comparison indicia being either positive or negative; and,
6) when the counterfeit comparison data is positive,
A) searches the chosen website for additional matches to the recognition template, and
B) informs the owner of the proprietary property of the counterfeit comparison data and the targeted website when the comparison data is positive.

16. The assembly for conducting a search of the internet according to claim 15, wherein, based on the counterfeit comparison data, the search computer identifies an address associated with the original chosen website.

17. The assembly for conducting a search of the internet wherein the search computer according to claim 16, chooses a subsequent targeted website with an internet address identical with the address associated with the original targeted website.

18. The assembly for conducting a search of the internet according to claim 17, wherein the search computer:
1) when the counterfeit comparison indicia is positive, chooses a subsequent targeted website having an address identical with the address associated with the original targeted website;
2) withdraws a new data set of image proprietary property from the database;
3) for the new data set, generates a subsequent recognition template;
4) withdraws subsequent content data from the subsequent chosen website;
5) converts the subsequent content data to a content template;
6) compares the subsequent content template to the subsequent recognition templates; and,
7) establishes a subsequent counterfeit comparison indicia being either positive or negative.
